(19) United States
(12) Patent Application Publication
(10) Pub. No.: US 2021/0126343 A1
(43) Pub. Date: Apr. 29, 2021

(54) MOBILE DEVICE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 16/789,509

(22) Filed: Feb. 13, 2020

(30) Foreign Application Priority Data
Oct. 29, 2019 (TW) 108138981

(51) Int. Cl. H01Q 1/24; H01Q 5/335

(52) U.S. Cl. CPC H01Q 1/243; H01Q 5/335

(57) ABSTRACT

A mobile device includes a feeding radiation element, a first radiation element, a second radiation element, and a dielectric substrate. The feeding radiation element includes a wide portion and a narrow portion. The wide portion of the feeding radiation element has a feeding point. The first radiation element is coupled to the wide portion of the feeding radiation element. The first radiation element and the narrow portion of the feeding radiation element substantially extend in opposite directions. The second radiation element is coupled to a ground voltage and has a meandering structure. The second radiation element is adjacent to the feeding radiation element and the first radiation element. The feeding radiation element, the first radiation element, and the second radiation element are disposed on the dielectric substrate. An antenna structure is formed by the feeding radiation element, the first radiation element, and the second radiation element.

### CROSS REFERENCE TO RELATED APPLICATIONS

This application claims priority of Taiwan Patent Application No. 108138981 filed on Oct. 29, 2019, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, 2500 MHz, and 2700 MHz. Some devices cover a small wireless communication area; these include mobile phones using Wi-Fi and Bluetooth systems and using frequency bands of 2.4 GHz, 5.2 GHz, and 5.8 GHz.

Antennas are indispensable elements for wireless communication. If an antenna used for signal reception and transmission has insufficient bandwidth, it will negatively affect the communication quality of the mobile device. Accordingly, it has become a critical challenge for antenna designers to design a small-size, wideband antenna element.

### BRIEF SUMMARY OF THE INVENTION

In an exemplary embodiment, the disclosure is directed to a mobile device that includes a feeding radiation element, a first radiation element, a second radiation element, and a dielectric substrate. The feeding radiation element includes a wide portion and a narrow portion. The wide portion of the feeding radiation element has a feeding point. The first radiation element is coupled to the wide portion of the feeding radiation element. The first radiation element and the narrow portion of the feeding radiation element substantially extend in opposite directions. The second radiation element is coupled to a ground voltage and has a meandering structure. The second radiation element is adjacent to the feeding radiation element and the first radiation element. The feeding radiation element, the first radiation element, and the second radiation element are all disposed on the dielectric substrate. An antenna structure is formed by the feeding radiation element, the first radiation element, and the second radiation element.

In some embodiments, the feeding radiation element substantially has an L-shape.

In some embodiments, the first radiation element substantially has a straight-line shape.

In some embodiments, the mobile device further includes a third radiation element. The third radiation element is coupled to the ground voltage and is adjacent to the second radiation element. An extension portion of the antenna structure is formed by the third radiation element.

In some embodiments, the third radiation element substantially has an L-shape.

In some embodiments, the antenna structure covers a first frequency band, a second frequency band, a third frequency band, a fourth frequency band, and a fifth frequency band. The first frequency band is from 2400 MHz to 2500 MHz. The second frequency band is from 5150 MHz to 5850 MHz. The third frequency band is from 3300 MHz to 3600 MHz. The fourth frequency band is from 3600 MHz to 4900 MHz. The fifth frequency band is from 5925 MHz to 7125 MHz.

In some embodiments, the inner length of the feeding radiation element is substantially equal to 0.25 wavelength of the second frequency band. The outer length of the feeding radiation element is substantially equal to 0.25 wavelength of the fourth frequency band.

In some embodiments, the length of the first radiation element is substantially equal to 0.25 wavelength of the fifth frequency band.

In some embodiments, the length of the second radiation element is substantially equal to 0.25 wavelength of the first frequency band.

In some embodiments, the length of the third radiation element is substantially equal to 0.25 wavelength of the third frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention;

FIG. 2 is a top view of a mobile device according to an embodiment of the invention;

FIG. 3 is a diagram of return loss of an antenna structure of a mobile device according to an embodiment of the invention; and

FIG. 4 is a diagram of radiation efficiency of an antenna structure of a mobile device according to an embodiment of the invention.

### DETAILED DESCRIPTION OF THE INVENTION

In order to illustrate the purposes, features and advantages of the invention, the embodiments and figures of the invention are shown in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

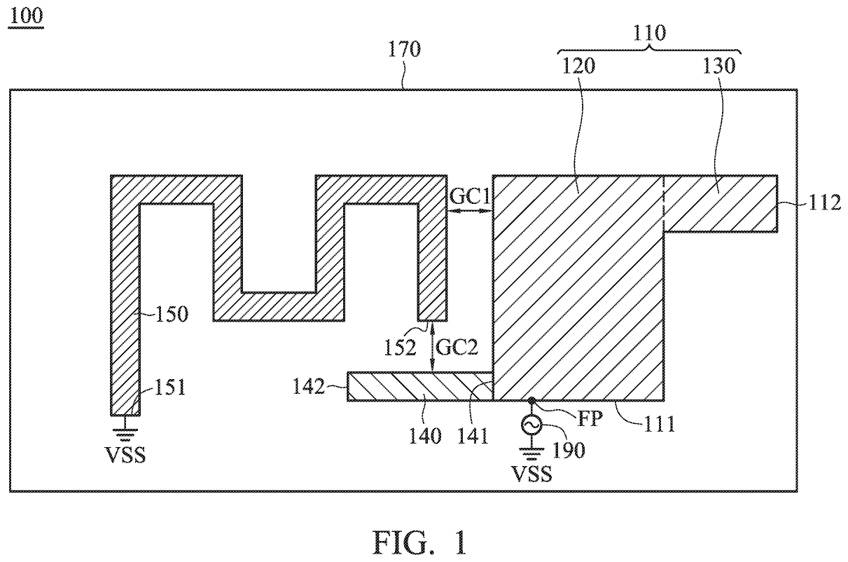

FIG. 1 is a top view of a mobile device 100 according to an embodiment of the invention. For example, the mobile device 100 may be a smartphone, a tablet computer, or a notebook computer. As shown in FIG. 1, the mobile device 100 at least includes a feeding radiation element 110, a first radiation element 140, a second radiation element 150, and a dielectric substrate 170. The feeding radiation element 110, the first radiation element 140, and the second radiation element 150 may all be made of metal materials, such as copper, silver, aluminum, iron, or an alloy thereof. The dielectric substrate 170 may be an FR4 (Flame Retardant 4) substrate, a PCB (Printed Circuit Board), or a FCB (Flexible Circuit Board). The feeding radiation element 110, the first radiation element 140, and the second radiation element 150 are all disposed on the dielectric substrate 170. It should be understood that the mobile device 100 may further include other components, such as a display device, a speaker, a touch control module, a power supply module, and a housing, although they are not displayed in FIG. 1.

The feeding radiation element 110 may substantially have a variable-width L-shape. The feeding radiation element 110 has a first end 111 and a second end 112. A feeding point FP is positioned at the first end 111 of the feeding radiation element 110. The second end 112 of the feeding radiation element 110 is an open end. The feeding point FP may be further coupled to a signal source 190, such as an RF (Radio Frequency) module. Specifically, the feeding radiation element 110 includes a wide portion 120 and a narrow portion 130 which are coupled to each other. The wide portion 120 is adjacent to the first end 111 of the feeding radiation element 110. The narrow portion 130 is adjacent to the second end 112 of the feeding radiation element 110. It should be noted that the term “adjacent” or “close” over the disclosure means that the distance (the space) between two corresponding elements is smaller than a predetermined distance (e.g., 5 mm or shorter), or means that the two corresponding elements are touching each other directly (i.e., the aforementioned distance or space therebetween is reduced to 0).

The first radiation element 140 may substantially have a straight-line shape. The first radiation element 140 has a first end 141 and a second end 142. The first end 141 of the first radiation element 140 is coupled to the wide portion 120 of the feeding radiation element 110 and is adjacent to the feeding point FP. The second end 142 of the first radiation element 140 is an open end. The second end 142 of the first radiation element 140 and the narrow portion 130 of the feeding radiation element 110 (or the second end 112 of the feeding radiation element 110) may substantially extend in opposite directions. In some embodiments, a combination of the feeding radiation element 110 and the first radiation element 140 substantially has an N-shape or an S-shape.

The second radiation element 150 may have a meandering structure, such as an M-shape, but it is not limited thereto. The second radiation element 150 has a first end 151 and a second end 152. The first end 151 of the second radiation element 150 is coupled to a ground voltage VSS. The second end 152 of the second radiation element 150 is adjacent to the feeding radiation element 110 and the first radiation element 140. The ground voltage VSS may be provided by a system ground plane (not shown) of the mobile device 100. A first coupling gap GC1 may be formed between the second radiation element 150 and the wide portion 120 of the feeding radiation element 110. A second coupling gap GC2 may be formed between the second radiation element 150 and the first radiation element 140.

In some embodiments, an antenna structure is formed by the feeding radiation element 110, the first radiation element 140, and the second radiation element 150. Such an antenna structure is planar and disposed on a surface of the dielectric substrate 170.

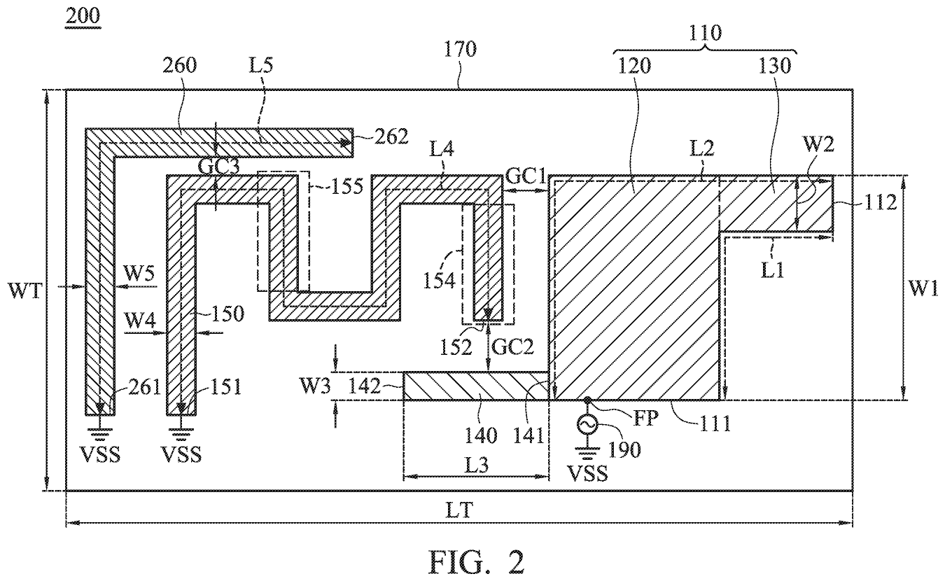

FIG. 2 is a top view of a mobile device 200 according to an embodiment of the invention. FIG. 2 is similar to FIG. 1. In the embodiment of FIG. 2, the mobile device 200 further includes a third radiation element 260, which is made of a metal material and is disposed on the dielectric substrate 170. The third radiation element 260 may substantially have an equal-width L-shape. The third radiation element 260 has a first end 261 and a second end 262. The first end 261 of the third radiation element 260 is coupled to the ground voltage VSS. The second end 262 of the third radiation element 260 is an open end, which is adjacent to the second radiation element 150. A third coupling gap GC3 may be formed between the third radiation element 260 and the second radiation element 150. The second end 262 of the third radiation element 260 and the second end 112 of the feeding radiation element 110 may substantially extend in the same direction. According to practical measurements, an extension portion of an antenna structure of the mobile device 200 is formed by the third radiation element 260, thereby increasing the operation bandwidth of the antenna structure. Other features of the mobile device 200 of FIG. 2 are similar to those of the mobile device 100 of FIG. 1. Accordingly, the two embodiments can achieve similar levels of performance.

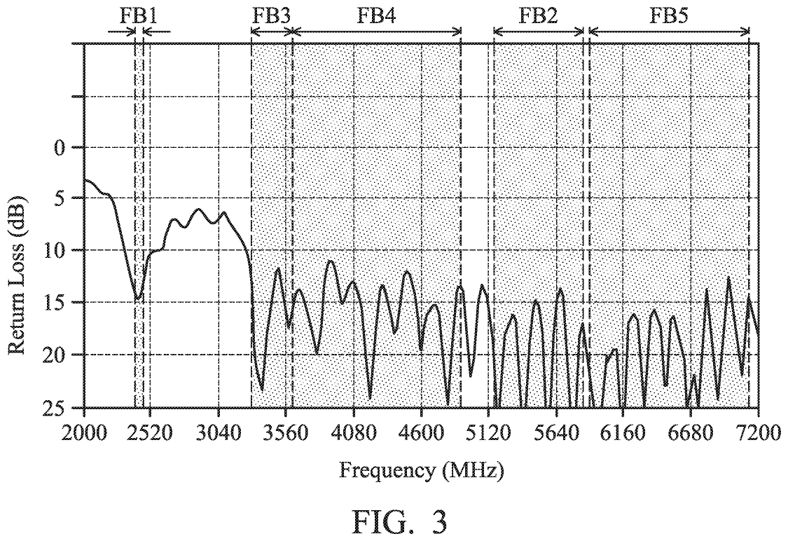

FIG. 3 is a diagram of return loss of the antenna structure of the mobile device 200 according to an embodiment of the invention. The horizontal axis represents the operation frequency (MHz), and the vertical axis represents the return loss (dB). According to the measurement of FIG. 3, when being excited by the signal source 190, the antenna structure of the mobile device 200 can cover a first frequency band FB1, a second frequency band FB2, a third frequency band FB3, a fourth frequency band FB4, and a fifth frequency band FB5. The first frequency band FB1 may be from 2400 MHz to 2500 MHz. The second frequency band FB2 may be from 5150 MHz to 5850 MHz. The third frequency band FB3 may be from 3300 MHz to 3600 MHz. The fourth frequency band FB4 may be from 3600 MHz to 4900 MHz. The fifth frequency band FB5 may be from 5925 MHz to 7125 MHz. It should be noted that in addition to the conventional Wi-Fi corresponding to the first frequency band FB1 and the second frequency band FB2, the antenna structure of the mobile device 200 can further cover the next-generation Wi-Fi corresponding to the third frequency band FB3, the fourth frequency band FB4, and the fifth frequency band FB5. Therefore, the antenna structure of the mobile device 200 can support at least the wideband operation of WLAN (Wireless Local Area Network).

In some embodiments, the operation principles of the antenna structure of the mobile device 200 are described as follows. The second radiation element 150 is excited to generate the first frequency band FB1. The feeding radiation element 110 is excited to generate both the second frequency band FB2 and the fourth frequency band FB4. The third radiation element 260 is excited to generate the third frequency band FB3. The first radiation element 140 is excited to generate the fifth frequency band FB5. Furthermore, the second radiation element 150 includes a first segment 154 and a second segment 155. The first segment 154 is at least partially perpendicular to the first radiation element 140. The second segment 155 is at least partially perpendicular to the third radiation element 260. According to practical measurements, such a design of orthogonal current paths can prevent the first radiation element 140, the second radiation element 150, and the third radiation element 260 from interfering with each other, thereby significantly increasing the isolation between the first frequency band FB1, the third frequency band FB3, and the fifth frequency band FB5.

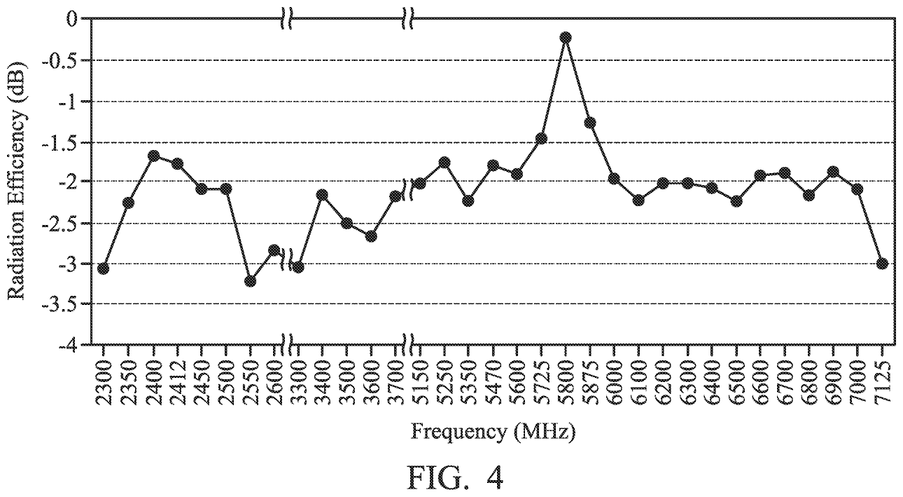

FIG. 4 is a diagram of radiation efficiency of the antenna structure of the mobile device 200 according to an embodiment of the invention. The horizontal axis represents the operation frequency (MHz), and the vertical axis represents the radiation efficiency (dB). According to the measurement of FIG. 4, the radiation efficiency of the antenna structure of the mobile device 200 can reach at least about −3 dB within the first frequency band FB1, the second frequency band FB2, the third frequency band FB3, the fourth frequency band FB4, and the fifth frequency band FB5. It can meet the requirements of practical application of WLAN communication.

In some embodiments, the element sizes of the mobile device 200 are described as follows. The total length LT of the antenna structure may be about 25 mm. The total width WT of the antenna structure may be about 10 mm. The inner length L1 of the feeding radiation element 110 may be substantially equal to 0.25 wavelength (λ/4) of the second frequency band FB2. The outer length L2 of the feeding radiation element 110 may be substantially equal to 0.25 wavelength (λ/4) of the fourth frequency band FB4. The length L3 of the first radiation element 140 may be substantially equal to 0.25 wavelength (λ/4) of the fifth frequency band FB5. The length L4 of the second radiation element 150 may be substantially equal to 0.25 wavelength (λ/4) of the first frequency band FB1. The length L5 of the third radiation element 260 may be substantially equal to 0.25 wavelength (λ/4) of the third frequency band FB3. Among the feeding radiation element 110, the width W1 of the wide portion 120 may be substantially 4 times the width W2 of the narrow portion 130. In addition, the width W2 of the narrow portion 130 of the feeding radiation element 110 may be substantially 2 times the width W3 of the first radiation element 140. The width W4 of the second radiation element 150 and the width W5 of the third radiation element 260 may be both substantially equal to the width W3 of the first radiation element 140. The width of the first coupling gap GC1 may be from 1 mm to 2 mm. The width of the second coupling gap GC2 may be from 1 mm to 2 mm. The width of the third coupling gap GC3 may be from 1 mm to 2 mm. The above ranges of element sizes are calculated and obtained according to many experiment results, and they help to optimize the operation bandwidth and impedance matching of the antenna structure of the mobile device 200.

The invention proposes a mobile device and a novel antenna structure therein. The proposed antenna structure can cover all of possible operation frequency bands of the next-generation Wi-Fi by incorporating radiation elements with meandering-extension and coupled-fed characteristics. In conclusion, the invention has at least the advantages of small size, wide bandwidth, and low manufacturing cost, and therefore it is suitable for application in a variety of mobile communication devices with narrow borders.

Note that the above element sizes, element shapes, and frequency ranges are not limitations of the invention. An antenna designer can fine-tune these settings or values according to different requirements. It should be understood that the mobile device and antenna structure of the invention are not limited to the configurations of FIGS. 1-4. The invention may merely include any one or more features of any one or more embodiments of FIGS. 1-4. In other words, not all of the features displayed in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
a feeding radiation element, comprising a wide portion and a narrow portion, wherein the wide portion has a feeding point;
a first radiation element, coupled to the wide portion, wherein the first radiation element and the narrow portion substantially extend in opposite directions;
a second radiation element, coupled to a ground voltage, and having a meandering structure, wherein the second radiation element is adjacent to the feeding radiation element and the first radiation element; and
a dielectric substrate, wherein the feeding radiation element, the first radiation element, and the second radiation element are disposed on the dielectric substrate;
wherein an antenna structure is formed by the feeding radiation element, the first radiation element, and the second radiation element.

2. The mobile device as claimed in claim 1, wherein the feeding radiation element substantially has an L-shape.

3. The mobile device as claimed in claim 1, wherein the first radiation element substantially has a straight-line shape.

4. The mobile device as claimed in claim 1, further comprising:
a third radiation element, coupled to the ground voltage, and disposed adjacent to the second radiation element, wherein an extension portion of the antenna structure is formed by the third radiation element.

5. The mobile device as claimed in claim 4, wherein the third radiation element substantially has an L-shape.

6. The mobile device as claimed in claim 4, wherein the antenna structure covers a first frequency band from 2400 MHz to 2500 MHz.

7. The mobile device as claimed in claim 6, wherein the antenna structure further covers a second frequency band from 5150 MHz to 5850 MHz.

8. The mobile device as claimed in claim 7, wherein the antenna structure further covers a third frequency band from 3300 MHz to 3600 MHz.

9. The mobile device as claimed in claim 8, wherein the antenna structure further covers a fourth frequency band from 3600 MHz to 4900 MHz.

10. The mobile device as claimed in claim 9, wherein the antenna structure further covers a fifth frequency band from 5925 MHz to 7125 MHz.

11. The mobile device as claimed in claim 10, wherein an inner length of the feeding radiation element is substantially equal to 0.25 wavelength of the second frequency band, and an outer length of the feeding radiation element is substantially equal to 0.25 wavelength of the fourth frequency band.

12. The mobile device as claimed in claim 10, wherein a length of the first radiation element is substantially equal to 0.25 wavelength of the fifth frequency band.

13. The mobile device as claimed in claim 10, wherein a length of the second radiation element is substantially equal to 0.25 wavelength of the first frequency band.

14. The mobile device as claimed in claim 10, wherein a length of the third radiation element is substantially equal to 0.25 wavelength of the third frequency band.

15. The mobile device as claimed in claim 10, wherein a width of the narrow portion of the feeding radiation element is substantially 2 times a width of the first radiation element.
